(19) United States
(12) Patent Application Publication
(10) Pub. No.: US 2024/0383278 A1
(43) Pub. Date: Nov. 21, 2024

(54) DRIVING RING AND HUB DEVICE INCLUDING THE SAME

(71) Applicant: POWERWAY INDUSTRIAL CO., LTD., Miaoli County (TW)

(72) Inventor: SHU-TZU TSAI TU, Miaoli County (TW)

(21) Appl. No.: 18/452,091

(22) Filed: Aug. 18, 2023

(30) Foreign Application Priority Data
May 17, 2023 (TW) 112204866

(51) Int. Cl. B60B 27/04; F16D 11/14

(52) U.S. Cl. CPC B60B 27/047; F16D 11/14

(57) ABSTRACT

A driving ring is configured to be assembled to and rotatable with a hub assembly and defines an axial direction, the drive ring includes a first axial side and a first circumferential side around the axial direction, the first axial side includes first ratchet teeth arranged around the axial direction and first grooves extending radially, the first circumferential side includes first engaging teeth arranged around the axial direction and engaged with the hub assembly, and between neighboring two of the first ratchet teeth is one of the first grooves. A hub device including the driving ring is provided, wherein the hub device further includes a hub assembly, a driving assembly an elastic member, and a shaft disposed through the hub assembly, the driving assembly and the elastic member.

### BACKGROUND OF THE INVENTION

### Field of the Invention

The present invention relates to a driving ring and a hub device including the same.

### Description of the Prior Art

Generally, the wheel of a bicycle is assembled to a hub, a shaft is passed through the hub, and the shaft is connected to the frame of the bicycle to support the wheel, for the bicycle to run on the road.

A ratchet driving assembly is usually arranged between the hub shell and the ratchet seat of the hub, the ratchet driving assembly includes two driving rings, and the two driving rings respectively have ratchet teeth meshed axially, so that the two driving rings can be engaged and unidirectionally rotatable with each other.

However, conventionally, the ratchets of the two driving rings are in contact with their inclined surfaces in the axial direction, and the ratchets of the two driving rings are all vertical or pointed. Therefore, the corners of the inclined surfaces of the two driving rings are easily interfered, and the relatively inclined tooth surfaces cannot be flatly contacted, so that the meshing effect of the ratchets of the two driving rings is not good, thus resulting in poor transmission effect and considerable wear between parts.

The present invention is, therefore, arisen to obviate or at least mitigate the above-mentioned disadvantages.

### SUMMARY OF THE INVENTION

The main object of the present invention is to provide a driving ring and a hub device including the same which provides a precise engagement and connection.

To achieve the above and other objects, a driving ring is provided. The driving ring is configured to be assembled to and rotatable with a hub assembly and defines an axial direction, the drive ring includes a first axial side and a first circumferential side around the axial direction, the first axial side includes first ratchet teeth arranged around the axial direction and first grooves extending radially, the first circumferential side includes first engaging teeth arranged around the axial direction and engaged with the hub assembly, and between neighboring two of the first ratchet teeth is one of the first grooves.

To achieve the above and other objects, a hub device is further provided, wherein the hub device includes: a hub assembly including a hub shell and a ratchet seat, the hub shell including an axial hole and a first annular toothed portion around the axial direction, the ratchet seat and the hub shell being axially opposite to each other, the ratchet seat including a second annular toothed portion around the axial direction; a driving assembly including the drive ring of claim 1, and a second drive ring, the second drive ring including an axial side and a second circumferential side around the axial direction, the axial side of the second drive ring including a plurality of second ratchet teeth arranged around the axial direction, the second circumferential side including a plurality of second engaging teeth arranged around the axial direction and engaged with the hub assembly, the plurality of first engaging teeth and the plurality of second engaging teeth being engaged with the first annular toothed portion and the second annular toothed portion, respectively; an elastic member abutted against and between the hub assembly and the driving assembly so that the plurality of first ratchet teeth and the plurality of second ratchet teeth are axially engaged with each other and unidirectionally rotatable relative to each other; and a shaft disposed through the hub assembly, the driving assembly and the elastic member.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a hub device of an exemplary embodiment of the present invention;

FIG. 2 is a breakdown drawing of the hub device of an exemplary embodiment of the present invention;

FIG. 3 is another breakdown drawing of the hub device of an exemplary embodiment of the present invention;

FIG. 4 is a cross-sectional view of the hub device of an exemplary embodiment of the present invention;

FIG. 5 is a stereogram of a drive ring of an exemplary embodiment of the present invention;

FIG. 6 is a partial enlarged cross-sectional view of FIG. 4;

FIGS. 7-9 are partial enlarged cross-sectional views of FIG. 6; and

FIG. 10 is a stereogram of another drive ring of another exemplary embodiment of the present invention.

### DETAILED DESCRIPTION OF THE PREFERRED EMBODIMENTS

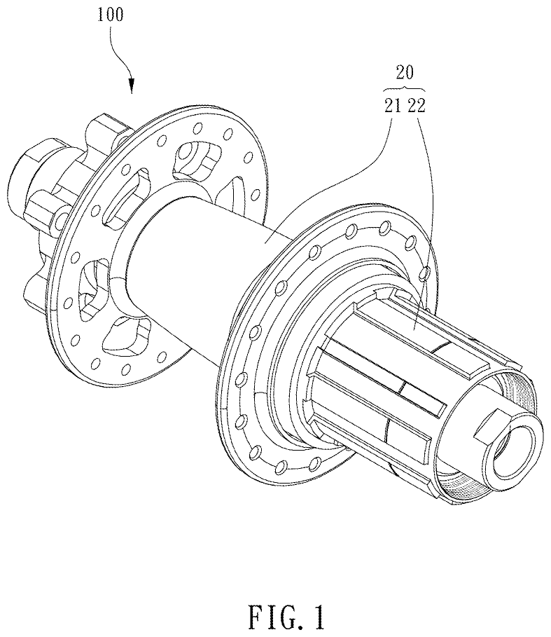

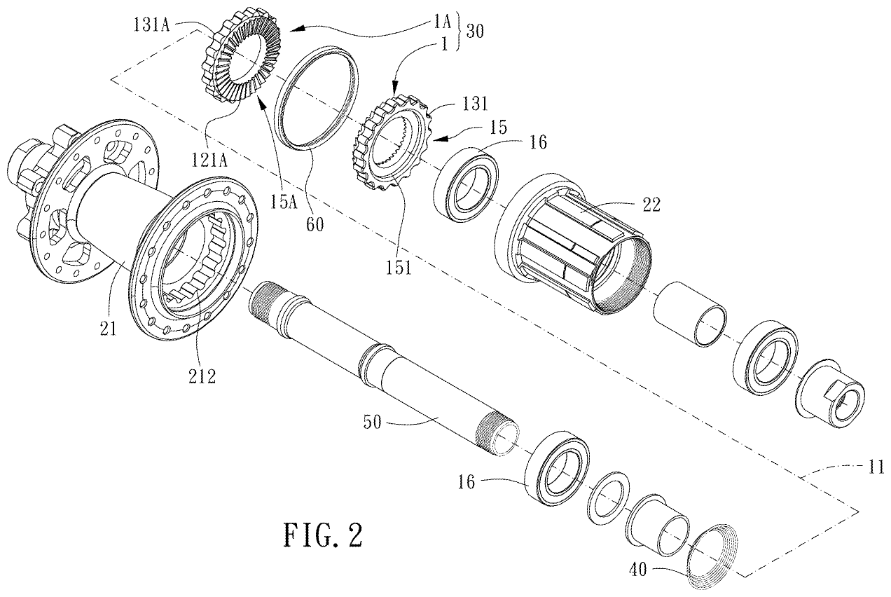

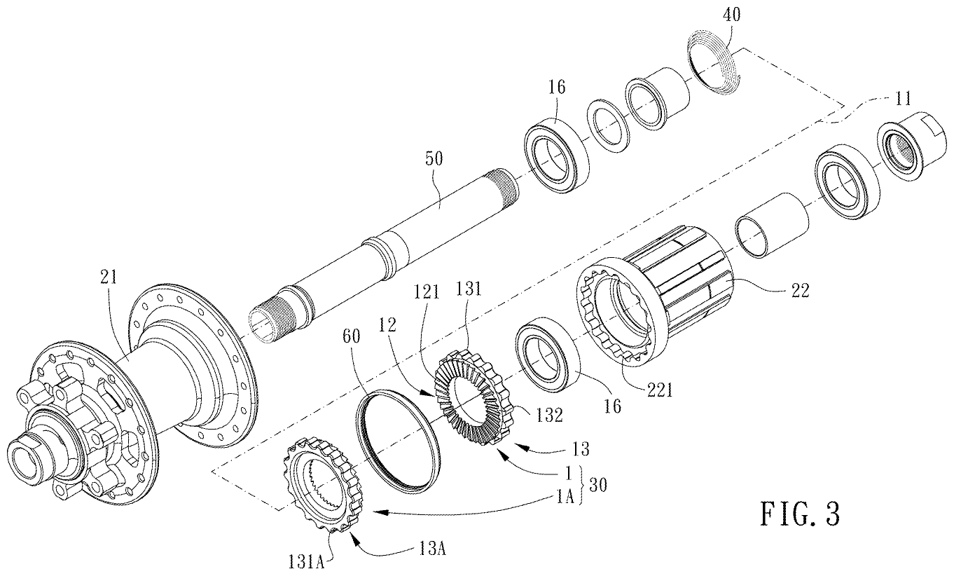

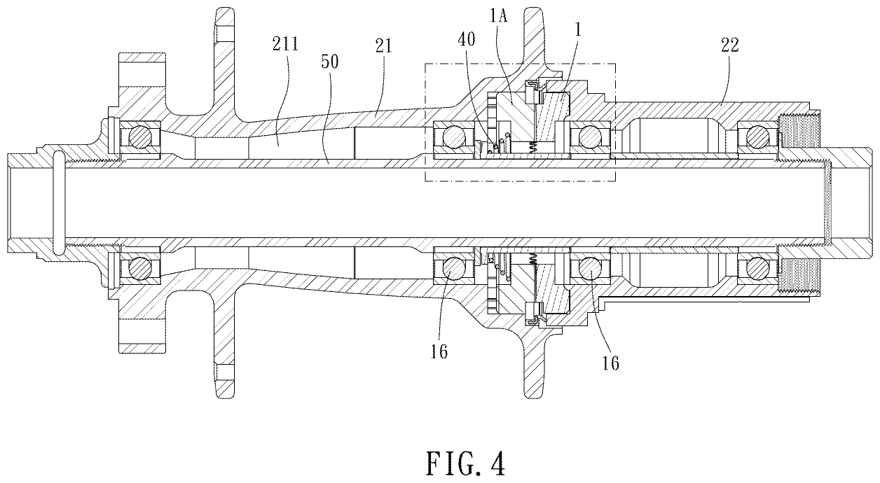

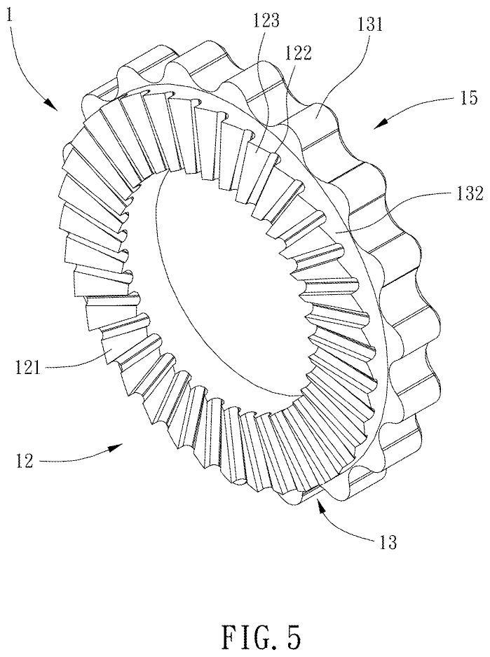

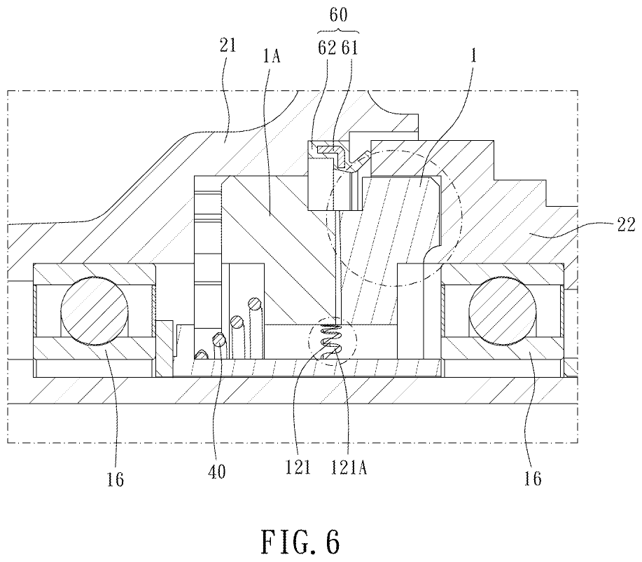

Please refer to FIGS. 1 to 9 for an exemplary embodiment of the present invention. A driving ring 1 is configured to be assembled to and rotatable with a hub assembly 20, the drive ring 1 defines an axial direction 11, the drive ring 1 includes a first axial side 12 and a first circumferential side 13 around the axial direction 11, the first axial side 12 includes a plurality of first ratchet teeth 121 arranged around the axial direction 11 and a plurality of first grooves 122 extending radially, the first circumferential side 13 includes a plurality of first engaging teeth 131 arranged around the axial direction 11 and engaged with the hub assembly 20, and between neighboring two of the plurality of first ratchet teeth 121 is one of the plurality of first grooves 122.

The first groove 122 may be arcuate (in this embodiment) or angled. Specifically, the first groove 122 a depth equal to or larger than one fourth an axial height difference of an inclined surface 123 of the first ratchet tooth 121. The neighboring two of the plurality of first ratchet teeth 121 are separated by one of the plurality of first grooves 122, each of the plurality of first grooves 122 has a fixed span, and the plurality of first grooves 122 are diametrically symmetric. The plurality of first grooves 122 allow peaks located therewithin so that the inclined surface 123 can contact a surface with its entire area.

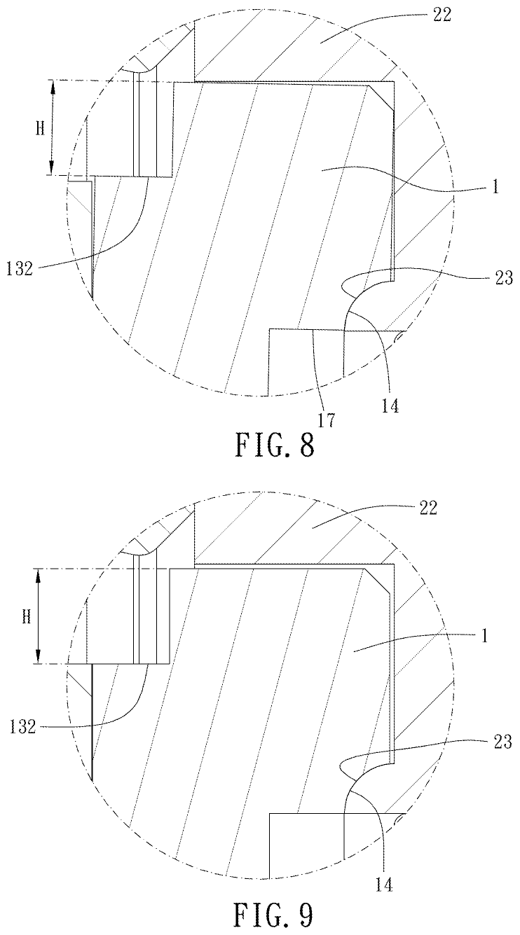

The drive ring further includes a first curved surface 14, and the first curved surface 14 is configured to be slidably abutted against the hub assembly 20 and pivotable relative to the axial direction 11 (FIG. 8 and FIG. 9). The number of the plurality of first ratchet teeth 121 is different from the number of the plurality of first engaging teeth 131. Preferably, the number of the plurality of first ratchet teeth 121 is preferably larger than the number of the plurality of first engaging teeth 131, and the number of the plurality of first ratchet teeth 121 is equal to or smaller than 1.5 times the number of the plurality of first engaging teeth 131, so that it is advantageous for smooth driving. There is a radial height difference H between the plurality of first ratchet teeth 121 and the plurality of first engaging teeth 131 for avoiding operation interference. Specifically, the plurality of first engaging teeth 131 includes an annular surface 132, and in the axial direction 11 the annular surface 132 has a width equal to or larger than one fourth a height of each of the plurality of first engaging teeth 131, which increases the structural strength and avoids operation interference.

The drive ring 1 further includes a second axial side 15 opposite to the first axial side 12, and an annular recess 151 is disposed on the second axial side 15 of the drive ring 1. Specifically, the first curved surface 14 extends about the axial direction 11, the drive ring 1 further includes an inner annular surface 17, the first curved surface 14 is connected and between the second axial side 15 and the inner annular surface 17 so that it provides good self-calibration and self-alignment effect. The first curved surface 14 may be concave or convex. In this embodiment, the first curved surface 14 is concave and the first curved surface 14 is arced so that it provides excellent self-calibration and self-alignment effect.

The invention further provides a hub device 100. The hub device 100 includes a hub assembly 20, a driving assembly 30, an elastic member 40 and a shaft 50.

The hub assembly 20 includes a hub shell 21 and a ratchet seat 22, the hub shell 21 includes an axial hole 211 and a first annular toothed portion 212 around the axial direction 11, the ratchet seat 22 and the hub shell 21 axial direction 11 are axially opposite to each other, and the ratchet seat 22 includes a second annular toothed portion 221 around the axial direction 11. The driving assembly 30 includes the drive ring 1, and a second drive ring 1A. The second drive ring 1A includes an axial side 15A and a second circumferential side 13A around the axial direction 11, the axial side 15A includes a plurality of second ratchet teeth 121A arranged around the axial direction 11, the second circumferential side 13A includes a plurality of second engaging teeth 131A arranged around the axial direction 11 and engaged with the hub assembly 20, and the plurality of first engaging teeth 131 and the plurality of second engaging teeth 131A are engaged with the first annular toothed portion 212 and the second annular toothed portion 221, respectively. The elastic member 40 is abutted against and between the hub assembly 20 and the driving assembly 30 so that the plurality of first ratchet teeth 121 and the plurality of second ratchet teeth 121A are axially engaged with each other and unidirectionally rotatable relative to each other. The shaft 50 is disposed through the hub assembly 20, the driving assembly 30 and the elastic member 40. In this embodiment, the drive ring 1 is engaged with the ratchet seat 22, and the second drive ring 1A is engaged in the hub shell 21; however, the arrangement relationship of the drive ring 1 and the second drive ring 1A is interchangeable.

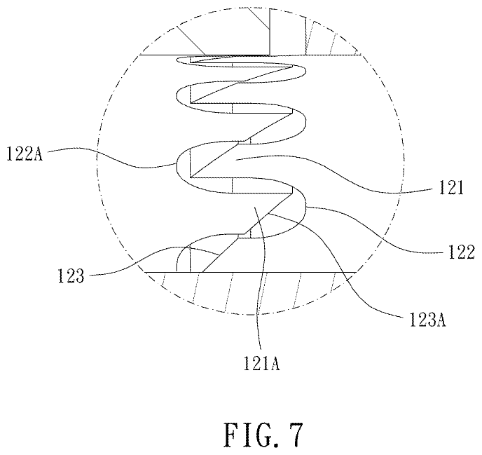

The axial side 15A further includes a plurality of second grooves 122A, between neighboring two of the plurality of second ratchet teeth 121A is one of the plurality of second grooves 122A, a peak of each of the plurality of first ratchet teeth 121 is located within one of the plurality of second grooves 122A, and a peak of each of the plurality of second ratchet teeth 121A is located within one of the plurality of first grooves 122 (FIG. 7). As such, the peak of each of the plurality of first ratchet teeth 121 and the peak of each of the plurality of second ratchet teeth 121A cannot interfere and be blocked, and thus the inclined surface 123 of each of the plurality of first ratchet teeth 121 and the inclined surface 123A of each of the plurality of second ratchet teeth 121A can be fully and sufficiently engaged with each other with their entire area and so that the drive ring 1 and the second drive ring 1A can engaged with each other precisely.

The hub assembly 20 further includes a second curved surface 23, and the first curved surface 14 and the second curved surface 23 face and abut each other. The hub device 100 further includes an annular member 60 disposed around the driving assembly 30, and the annular member 60 is annularly abutted against and between the hub shell 21 and the ratchet seat 22. The annular member 60 includes a metal ring body 61 and an elastic ring body 62 within which the metal ring body 61 is disposed. The metal ring body 61 has an L-shaped cross-section, the elastic ring body 62 has a Z-shaped cross-section, and an end of the elastic ring body 62 is inclined to the axial direction 11 and abutted against an axial end surface of the ratchet seat 22. The elastic member 40 axially urges the second drive ring 1A toward the second drive ring 1A. Through cooperation of the first curved surface 14 and the second curved surface 23, it carries out effective self-calibration and self-alignment of the drive ring and the second drive ring 1A (FIG. 8 and FIG. 9), which improves the transmission effect and reduce wear of parts. Preferably, a bearing 16 is disposed between the hub shell 21 and the shaft 50, and a bearing 16 is disposed between the ratchet seat 22 and the shaft 50, which lowers the rotational friction resistance.

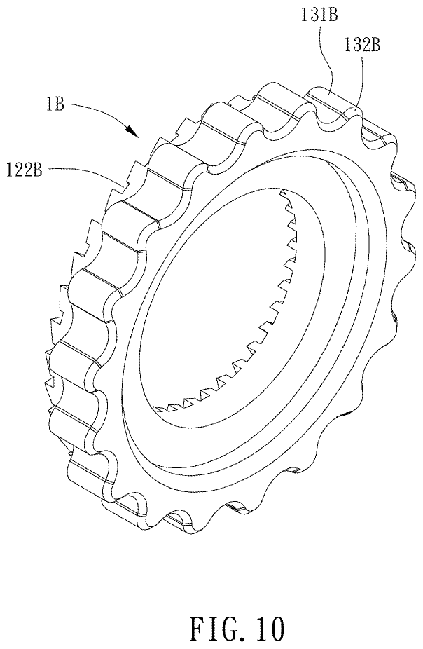

In other exemplary embodiments, the first groove 122B of the drive ring 1B is angled, a chamfer 132B (curved chamfer or flat chamfer) is disposed at a periphery of the first engaging tooth 131B of the drive ring 1B (FIG. 10), which provides further improvement of the self-alignment of the meshing of the drive ring with the second drive ring.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A driving ring configured to be assembled to and rotatable with a hub assembly and defining an axial direction, the drive ring including a first axial side and a first circumferential side around the axial direction, the first axial side including a plurality of first ratchet teeth arranged around the axial direction and a plurality of first grooves extending radially, the first circumferential side including a plurality of first engaging teeth arranged around the axial direction and engaged with the hub assembly, between neighboring two of the plurality of first ratchet teeth being one of the plurality of first grooves.

2. The driving ring of claim 1, wherein there is a radial height difference between the plurality of first ratchet teeth and the plurality of first engaging teeth.

3. The driving ring of claim 1, wherein the drive ring further includes a first curved surface, and the first curved surface is configured to be slidably abutted against the hub assembly and pivotable relative to the axial direction.

4. The driving ring of claim 1, wherein the first groove is arcuate or angled.

5. The driving ring of claim 4, wherein the first groove has a depth equal to or larger than one fourth an axial height difference of an inclined surface of the first ratchet tooth.

6. The driving ring of claim 5, wherein the number of the plurality of first ratchet teeth is different from the number of the plurality of first engaging teeth; there is a radial height difference between the plurality of first ratchet teeth and the plurality of first engaging teeth; the drive ring further includes a second axial side opposite to the first axial side, and an annular recess is disposed on the second axial side of the drive ring; the neighboring two of the plurality of first ratchet teeth are separated by one of the plurality of first grooves; each of the plurality of first grooves has a fixed span; the plurality of first grooves are diametrically symmetric; the drive ring further includes a first curved surface, and the first curved surface is configured to be slidably abutted against the hub assembly and pivotable relative to the axial direction; the first curved surface extends about the axial direction; the drive ring further includes an inner annular surface, and the first curved surface is connected and between the second axial side and the inner annular surface; the first curved surface is concave; the first curved surface is arched; the plurality of first engaging teeth include an annular surface, and in the axial direction the annular surface has a width equal to or larger than one fourth a height of each of the plurality of first engaging teeth; the number of the plurality of first ratchet teeth is equal to or smaller than 1.5 times the number of the plurality of first engaging teeth.

7. A hub device including:
a hub assembly including a hub shell and a ratchet seat, the hub shell including an axial hole and a first annular toothed portion around the axial direction, the ratchet seat and the hub shell being axially opposite to each other, the ratchet seat including a second annular toothed portion around the axial direction;
a driving assembly including the drive ring of claim 1, and a second drive ring, the second drive ring including an axial side and a second circumferential side around the axial direction, the axial side of the second drive ring including a plurality of second ratchet teeth arranged around the axial direction, the second circumferential side including a plurality of second engaging teeth arranged around the axial direction and engaged with the hub assembly, the plurality of first engaging teeth and the plurality of second engaging teeth being engaged with the first annular toothed portion and the second annular toothed portion, respectively;
an elastic member abutted against and between the hub assembly and the driving assembly so that the plurality of first ratchet teeth and the plurality of second ratchet teeth are axially engaged with each other and unidirectionally rotatable relative to each other; and
a shaft disposed through the hub assembly, the driving assembly and the elastic member.

8. The hub device of claim 7, wherein the axial side further includes a plurality of second grooves extending radially, between neighboring two of the plurality of second ratchet teeth is one of the plurality of second grooves, a peak of each of the plurality of first ratchet teeth is located within one of the plurality of second grooves, and a peak of each of the plurality of second ratchet teeth is located within one of the plurality of first grooves.

9. The hub device of claim 7, further including an annular member disposed around the driving assembly, wherein the annular member is annularly abutted against and between the hub shell and the ratchet seat.

10. The driving ring of claim 9, wherein the annular member includes a metal ring body and an elastic ring body within which the metal ring body is disposed.
